(19) United States
(12) Patent Application Publication
(10) Pub. No.: US 2023/0240200 A1
(43) Pub. Date: Aug. 3, 2023

(54) Use of an organo-mineral composition by foliar application to stimulate plant development in the presence of at least one abiotic stress or biotic stress

(71) Applicant: OLMIX, Brehan (FR)

(72) Inventors: Bruno Daridon, Malzeville (FR); Clément Leverge, Reguiny (FR); Thierry Audier, Saint Emilion (FR); Pi Nyvall-Collen, Roscoff (FR)

(21) Appl. No.: 18/012,738

(22) PCT Filed: Jun. 16, 2021
(86) PCT No.: PCT/EP2021/066251

§ 371 Date: Dec. 23, 2022

(30) Foreign Application Priority Data
Jun. 26, 2020 (FR) FR2006760

(51) Int. Cl. A01G 7/06; A01P 3/00; A01N 65/03; A01N 59/00; A01N 25/02; A01P 21/00

(52) U.S. Cl. CPC A01G 7/06; A01P 3/00; A01N 65/03; A01N 59/00; A01N 25/02; A01P 21/00; A01N 2300/00

(57) ABSTRACT

The invention relates to the use of an organo-mineral composition by foliar application to stimulate plant development in the presence of at least one abiotic stress, said composition comprising the following compounds:

| | |
|---|---|
| algae extract | 5 to 50% |
| soluble silica expressed as SiO₂ | 0.5 to 2.5% |
| mineral nutrients | 0 to 30% |
| trace elements | 0 to 12% |
| organic acids | 0 to 30%, |

the percentages being expressed as weight of dry matter of each of said compounds with respect to the total weight of dry matter of said organo-mineral composition.

### FIELD OF THE INVENTION

The field of the invention is that of plant biostimulation and crop protection against phytopathogenic fungi.

More specifically, the invention relates to the use of an organo-mineral composition by foliar application to stimulate plant development in the presence of at least one abiotic stress.

### STATE OF THE ART

In agriculture, the use of biostimulants of natural origin is becoming increasingly widespread and is proving to be an effective alternative to synthetic inputs, such as fertilisers or pesticides from the chemical industry.

These biostimulants contribute to crop quality by improving the assimilation of mineral elements by plants, with equivalent fertilisation, and by increasing resistance to abiotic stresses.

It is also known that it is possible to reduce the use, the dose or the frequency of use of plant protection products, and in particular fungicides, by using natural active ingredients which elicit plant defence mechanisms or which are themselves fungicidal or fungistatic, while presenting a low overall toxicity.

In particular, it is known to use algae or their extracts on plants and soil to improve nutrition, abiotic stress resistance and biotic stress resistance of plants by eliciting their defence mechanisms. Due to the numerous active ingredients that can be extracted from algae, such as marine trace elements, polysaccharides and sulphur oligo-saccharides, rare sugars, uronic acids, polyphenols, proteins, amino acids, betaines, secondary metabolites, pigments, osmolytes, plant hormones, . . . , the potential modes of action of algae are very diverse and depend on the algae species selected and the extraction process used.

Polysaccharides, and in particular sulphur polysaccharides, which are mainly fucoidans for brown algae, carrageenans for red algae or ulvans for green algae, are known to make an important contribution to the biological activity of algae extracts. The defence mechanism eliciting effect of red algae and carrageenans has been demonstrated and quantified for example in the following papers:
Saucedo et al. BMC Plant Biology (2019), Oligo-carrageenan kappa increases glucose, trehalose and TOR-P and subsequently stimulates the expression of genes involved in photosynthesis, and basal and secondary metabolisms in Eucalyptus globulus19:258, https://doi.org/10.1186/s12870-019-1858-z
C. Lemonnier-Le Penhuizic a, C. Chatelet a, B. Kloareg b, P. Potin, Plant Science 160 (2001) 1211-1220, Carrageenan oligosaccharides enhance stress-induced microspore embryogenesis in Brassica oleracea var. italica
Laurence Mercier, Claude Lafitte, Gisèle Borderies, Xavier Briand, Marie-Thérèse Esquerrè-Tugayè, and Joêlle Fournier, The algal polysaccharide carrageenan can act as an elicitor of plant defense, New Phytologist (2001), 149: 43-51
Silvia Saucedo, Rodrigo A. Contreras, Alejandra Moenne, Oligo-carrageenan kappa increases C, N and S assimilation, auxin and gibberellin contents, and growth in Pinus radiata trees, J. For. Res, DOI 10.1007/s11676-015-0061-9
Alberto González, Rodrigo A. Contreras, Gustavo Zúñiga and Alejandra Moenne, Oligo-Carrageenan Kappa-Induced Reducing Redox Status and Activation of TRR/TRX System Increase the Level of Indole-3-acetic Acid, Gibberellin A3 and trans-Zeatin in Eucalyptus globulus Trees, Molecules 2014, 19, 12690-12698; doi:10.3390/molecules190812690
Shukla P S, Borza T, Critchley A T and Prithiviraj B (2016), Carrageenans from Red Seaweeds As Promoters of Growth and Elicitors of Defense Response in Plants, Front. Mar.Sci.3:81. doi: 10.3389/fmars.2016.0008
Josiane Courtois, Oligosaccharides from land plants and algae: production and applications in therapeutics and biotechnology, www.sciencedirect.com, Current Opinion in Microbiology 2009, 12:261-273
M. E. López-Mosquera & P. Pazos (1997) Effects of Seaweed on Potato Yields and Soil Chemistry, Biological Agriculture & Horticulture: An International Journal for Sustainable Production Systems, 14:3, 199-205, DOI: 10.1080/01448765.1997.9754810
US 2011/0099898A1, METHOD TO STIMULATE CARBON FIXATION IN PLANTS WITH AN AQUEOUS SOLUTION OF OLIGO-CARRAGEENANS SELECTED FROM KAPPA1, KAPPA2, LAMBDA OR IOTA.

In addition, the following scientific articles report the eliciting effect of defence mechanisms of green algae and ulvans: Valerie Jaulneau, Claude Lafitte, Christophe Jacquet, Sylvie Fournier, Sylvie Salamagne, Xavier Briand, Marie-Thérèse Esquerré-Tugay and Bernard Dumas, (2010), Ulvan, a Sulfated Polysaccharide from Green Algae, Activates Plant Immunity through the Jasmonic Acid Signaling Pathway, Journal of Biomedicine and Biotechnology, Volume 2010, Article ID 525291, 11 pages, doi:10.1155/2010/525291; El-Sheekh, M; el-Saied A el-D, Cytobios: a prestige international journal of cell biology, 101/396,23-35 2000, Effect of crude seaweed extracts on seed germination, seedling growth and some metabolic processes of Vicia faba L; Bi et all, 2003, dose dependent and time course elicitor activity of Codium elongatum and Ulva lactulus (green algae) of karachi coast, Pak. J. Bot. 35 (4), 511-518, 2003; Katarzyna Godlewska, Izabela Michalak, Aukasz Tuhy, and Katarzyna Chojnacka, Plant Growth Biostimulants Based on Different Methods of Seaweed Extraction with Water, BioMed Research International, Volume 2016, Article ID 5973760, 11 pages, http://dx.doi.org/10.1155/2016/5973760.

However, different activities are observed within the polysaccharide family, due to structural differences that influence the affinity of these ligands to receptors on the plant cell surface.

The use of silica in biostimulant or biocontrol fertiliser formulations for plants has also been considered, in an active form that can be assimilated by plants, and in particular in the form of monomeric or dimeric orthosilicic acid.

The defense mechanism eliciting effects and biostimulatory effects of several silica formulations are reported for example in Manivannan A and Ahn Y-K (2017), Silicon Regulates Potential Genes Involved in Major Physiological Processes in Plants to Combat Stress, Front. Plant Sci. 8:1346. doi: 10.3389/fpls.2017.01346, Wang M, Gao L, Dong S, Sun Y, Shen Q and Guo S (2017), Role of Silicon on Plant-Pathogen Interactions, Front. Plant Sci. 8:701, doi: 10.3389/fpls.2017.00701, Guerriero G, Hausman J-F and Legay S (2016), Silicon and the Plant Extracellular Matrix, Front. Plant Sci. 7:463, doi: 10.3389/fpls.2016.00463, Coskun D, Britto D T, Huynh W Q and Kronzucker H J (2016), The Role of Silicon in Higher Plants under Salinity and Drought Stress, Front. Plant Sci. 7:1072, doi: 10.3389/fpls.2016.0107, Devrim Coskun, Rupesh Deshmukh, Humira Sonah, James G. Menzies, Olivia Reynolds, Jian Feng Ma5, Herbert J. Kronzucker and Richard R., Belanger, (2018), The controversies of silicon's role in plant biology, New Phytologist (2019) 221: 67-85, doi: 10.1111/nph.15343.

A disadvantage of monomeric orthosilicic acid is its instability in aqueous solution in the pH ranges compatible with use on plants. Monomeric silicic acid (commonly referred to by its acronym MOSA), with the formula Si(OH)₄, polymerises in water as soon as its concentration exceeds a threshold, becoming both insoluble and inactive on plants, and can therefore only be used in very dilute form.

Formulations based on seaweed extracts and trace elements and formulations based on MOSA silica and trace elements have also been proposed

The biological activity of silica or algae or their extracts incorporated in known fertiliser formulations, and in the presence or absence of trace elements, was found to be limited.

There is therefore a need for new stable, simple and low-cost formulations, active at low doses in the field, particularly for field crops, to stimulate plant development in the presence of abiotic stress.

### OBJECTIVES OF THE INVENTION

In particular, the invention aims to provide a technique for stimulating plant development that is effective at low dosage, simple to implement, inexpensive and compatible with environmentally friendly cultivation.

A further objective of the invention is to provide such a technique which confers protection to plants against phytopathogenic fungi.

### STATEMENT OF THE INVENTION

The present invention relates to the use of an organo-mineral composition by foliar application to stimulate plant development in the presence of at least one abiotic stress, said composition comprising algae extract and soluble silica in aqueous solution.

In the context of the invention, the term “algae extract” means a seaweed juice obtained by pressing fresh seaweed, possibly with the addition of additives, or a substance obtained from fresh or dried seaweed by any extraction process, whether or not assisted, solid-liquid separation, fractionation or concentration process known in the art.

In the context of the invention, the term “soluble silica” or “MOSA” means a stabilised formulation of monomeric or dimeric orthosilicic acid.

Preferably, said composition comprises the following compounds:

| | |
|---|---|
| algae extract | 5 to 50% |
| soluble silica expressed as SiO₂ | 0.5 to 2.5% |
| mineral nutrients | 0 to 30%. |
| trace elements | 0 to 12% |
| organic acids | 0 to 30%. |

the percentages being expressed as weight of dry matter of each of said compounds with respect to the total weight of dry matter of said organo-mineral composition.

The inventors have indeed discovered, in a surprising and unexpected way, a synergistic effect between algae extract and soluble silica, when incorporated in the proportions indicated above, improving the stimulation of plant development in the presence of abiotic stress.

Preferably, the percentage of algae extract is between 5-30% dry matter in relation to the total dry matter.

Preferably, the percentage of soluble silica is between 1.2 and 2.5% of dry matter in relation to the total dry matter expressed as SiO₂.

Preferably, said soluble silica comprises stabilised monomeric orthosilicic acid.

Typically, said use further improves the resistance of plants to phytopathogenic fungi.

Also typically, said fungal plant pathogen belongs to the group comprising at least:
botrytis;
microorganism causing late blight;
fungus causing oidium;
fungus causing septoria;
fungus causing rust.

Preferably, said algae extract of said composition is an extract of red algae and/or green algae.

Even more preferably, said algae extract is an extract of algae from the family Solieriaceae and/or Ulvaceae.

In a preferred embodiment of the invention, said composition is in liquid form.

The organo-mineral composition according to the invention is generally used in 1 to 10 applications at a rate of between 0.5 and 5 l/ha/application.

Typically, said development of said plant results in the improvement of at least one of the following parameters under normal conditions or under biotic and abiotic stress:
height of the plants;
shank diameter;
photosynthetic activity;
vegetative development index NDVI;
gross or dry above-ground biomass;
fresh or dry root biomass;
mineral content of the above-ground biomass;
number of sheets;
number of flowers;
number of fruits;
performance;
quality parameter of the harvest, such as the quality of the grape must, the protein content or the baking quality of a cereal, the homogeneity of the fruits;
genomic and/or transcriptomic and/or metabolomic changes in the plant in the absence of stress, under biotic stress and/or under abiotic stress.

Typically, an organo-mineral composition according to the invention is intended to be used on annual or biennial field crops and on perennial plants.

In an advantageous embodiment of the invention, said mineral nutrients are a source of nitrogen, potassium, phosphorus and/or sulphur.

The invention also relates to an aqueous composition comprising the following compounds:

| | |
|---|---|
| algae extract | 5 to 50% |
| soluble silica expressed as SiO₂ | 0.5 to 2.5 |
| mineral nutrients | 0 to 30%. |
| trace elements | 0 to 12% |
| Organic acids | 0 to 30%. |

the percentages being expressed as weight of dry matter of each of said compounds with respect to the total weight of dry matter of said organo-mineral composition, the total being adjusted to 100%.

### DETAILED DESCRIPTION OF THE INVENTION

The present invention provides a solution to the above-mentioned technical problem, by means of new organo-mineral compositions capable of improving the development of plants under at least one abiotic stress.

### Use According to the Invention

The present invention thus relates to the use of a particular organo-mineral composition improving the development of a plant.

In other words, the present invention thus relates to a method for improving the development of a plant, by foliar application, of said particular organo-mineral composition.

By “plant” is meant, in the sense of the present invention, mono-cotyledonous plants and dicotyledonous plants. Plants, in the sense of the invention, include cultivated plants and, in particular, field crops, plants cultivated for horticulture or market gardening, arboriculture or for livestock meadows.

Plants grown for arboriculture include fruit trees, small fruits, vines, ornamental plants.

Plants cultivated for horticulture or market gardening include, for example, flowering and/or ornamental plants and vegetable and/or market gardening plants.

“Annual (or biennial) field crops” include, but are not limited to, cereal straw crops, maize, sunflower, rapeseed, soybeans, peanuts, sesame, flax, cotton, potatoes, beetroot and forage crops such as alfalfa or clover.

Straw cereals include wheat, barley, rice, maize, oats, spelt, rye, quinoa, millet and others.

Plants grown for fruit production include plum, peach, apple, pear, apricot, cherry, fig, walnut, hazelnut, almond, grapevine.

Vegetable and/or market garden crops include protein peas, beans, flageolet beans, peas, spinach, endive, crosnes, yams, sweet potatoes, Jerusalem artichokes, salads (endive, lettuce, lamb's lettuce, romaine, escarole, . . . ), celery, cabbage, spinach, fennel, sorrel, chard, rhubarb, asparagus, leek, bulbs of Amaryllidaceae such as garlic, shallots, onions, flowering vegetables such as cauliflower, broccoli, fruiting vegetables such as aubergine, avocado, cucumber, gherkin, squash, zucchini, melon, watermelon, pepper, tomatoes, . . . .

### Composition

The organo-mineral composition used in the context of the invention comprises, in addition to water, the following compounds

| | |
|---|---|
| algae extract | 5 to 50% |
| soluble silica expressed as SiO₂ | 0.5 to 2.5 |
| mineral nutrients | 0 to 30% |
| trace elements | 0 to 12% |
| Organic acids | 0 to 30% |

the percentages of the compounds being expressed as weight of dry matter of each of said compounds with respect to the total weight of dry matter of said organo-mineral composition.

Preferably, a composition according to the invention comprises a percentage of concentrated algae extract ranging from 5 to 30% dry matter based on the total dry matter of the composition.

Preferably, a composition according to the invention comprises a percentage of soluble silica ranging from 1.2 to 2.5% of dry matter with respect to the total dry matter of the composition, expressed as SiO₂.

Preferably, the soluble silica is stabilised monomeric orthosilicic acid.

The algae extracts are preferably extracts of algae from the Solieriaceae and/or Ulvaceae family.

Preferred compositions according to the invention have for example the following formulations:

| Raw material | Compo- | Compo- | Compo- | Compo- | Compo- |
|---|---|---|---|---|---|
| (% DM/ | sition | sition | sition | sition | sition |
| MS total) | C1 | C2 | C3 | C4 | C5 |
| Green algae | 31.3 | 10.4 | | 5.2 | |
| extract | | | | | |
| Red algae | | 20.8 | 34 | 26 | 38.2 |
| extract | | | | | |
| MOSA silica | 1.7 | 1.7 | 2.4 | 1.7 | 2.4 |
| (expressed | | | | | |
| as SIO₂) | | | | | |
| Silica stabiliser | 13.6 | 13.7 | 17.9 | 13.7 | 20.1 |
| Trace elements | 10.4 | 10.4 | 6.8 | 10.4 | 7.6 |
| Mineral salts | 28.7 | 28.6 | 18.7 | 28.6 | 21 |
| Organic acid | 14.3 | 14.3 | 9.3 | 14.3 | 10.5 |

The green algae extract incorporated in compositions C1, C2 and C4 is derived from algae of the species ulva armoricana.

The red algae extract incorporated in compositions C2, C4 and C5 is derived from algae of the species Solieria chordalis.

The red algae extract incorporated in the C3 compositions is a mixture of ¾ of an algae extract from algae of the species Solieria chordalis and ¼ of an algae extract from algae of the species Euchema spinosum.

The silica stabiliser is respectively:
for composition C1: polyethylene glycol and tertiary amine, organic acid;
for compositions C2 to C5: natural polyol and tertiary amine.

### Formulation of the Composition

In general, the composition according to the invention is a composition in aqueous medium which is in liquid form.

### Implementation of the Composition

In general, the composition according to the invention is suitable for foliar application.

The composition according to the invention can be used at doses ranging from 0.5 to 5 L/ha of cultivated soil per application, in 1 to 10 applications per crop cycle, diluted in a spray mixture intended to be applied at a rate of between 50 and 1000 L/ha.

In general, unless otherwise stated, the boundaries of the intervals mentioned in the present application are included in said intervals. The embodiments described in the present application may, unless otherwise stated, be combined with each other.

The invention is further illustrated in a non-limiting manner by the following examples, in which they are expressed as a percentage of dry matter of each component of a composition with respect to the total dry matter of that composition.

### EXAMPLES

The compositions C1 to C4 mentioned in the following examples correspond to the compositions C1 to C4 described above.

### Example 1: Transcriptomic Analysis Trials on Tomato from a GHP Trial Under Controlled Conditions

Tomato seeds of the Plaisance variety were sown in potting soil. Eleven days after sowing, the seedlings were transplanted into one litre pots containing the same substrate and growth was continued in a greenhouse compartment under natural light and maintained at 24° C. during the day and 18° C. at night. The plants were fed with 50 ml of Angibaud & Specialties trademark Soluveg ALC35 at 2 g·l⁻¹ every 7 days and 50 ml of water twice a week.

25 days after sowing, a dilute liquid solution was sprayed on the leaves of the plants at the runoff limit. According to the plants, this liquid solution consists of water (hereinafter referred to as NT for untreated), a green algae juice of the same species as that incorporated in composition C1 at 20% dry matter diluted to 1:50 hereinafter referred to as JAV1, a mixture of a commercial silica containing trace elements and mineral salts, composed of 9.7% expressed as SiO₂ on a dry matter basis of monomeric orthosilicic acid, 78.9% on a dry matter basis of polyethylene glycol, a tertiary amine, an organic acid, intended to stabilise the silica, 3% on a dry matter basis of trace elements and 8.7% on a dry matter basis of mineral salts, diluted to 1:500, and hereinafter referred to as SI1, or to composition C1 diluted to 1:50.

Thus C1 and SI1 are adjusted to the same applied dose of silica and JAV1 and SI1 are applied to the same applied dose of algal juice.

Two hours and forty-eight hours after the application of the NT composition or the JA1, C1 and SI1 compositions, 4 samples of approximately 50 mg of leaf from the second leaf stage, corresponding to 4 technical replicates, were taken from 4 different plants. Once cut, each leaf sample was transferred into an individual 2 mL plastic tube with a micro-hole in the cap and a steel grinding ball. The tubes were immediately immersed in liquid nitrogen and stored at −80° C. before performing RNA extractions. These operations were repeated for each modality and for each biological replicate separated by 24 h A and B, at the 2 kinetic times (2 h and 48 h post treatment).

Extractions were performed separately by biological replicate (A and B) and by kinetic time (2 h and 48 h). The 16 tubes (4 tubes per modality, for a biological repeat and for a kinetic time) stored at −80° C. were removed from the freezer and immediately placed in liquid nitrogen. The samples were ground at 20 Hz for 20 seconds before being placed back into the liquid nitrogen.

RNAs were extracted using the QiagenRNeasyR Protect Mini Kit, with a mixture of RLT buffer and β-Mercaptoethanol for sample lysis. The 4 technical replicates were bulked post-lysis, by transferring 100 μL of the lysa from each replicate into a new tube containing 225 μL of Ethanol. A DNase treatment (QIAGEN RNase-Free DNase Set) was performed during extraction, according to the supplier's instructions. The quality of the extracted total RNAs was then checked on an RNA 6000 Nano chip on Bioanalyzer 2100 (Agilent). Compliant RNAs were sent to the Transcriptome platform of the Plant Genomics Research Unit (Evry, France). The Transcriptome platform proceeded to the quantification of the samples (Ribogreen) as well as to a new quality control.

Hybridisations were performed on Agilent (trademark) microarrays, each comprising 33913 target genes corresponding to the ITAG2.3 annotation of the tomato genome, with sense and antisense probes for each gene (each replicated twice). For each comparison (NT vs. JA1, NT vs. C1 and NT vs. SI1) and for each biological repeat (A and B), a dye-swap hybridisation replicate on slide with inversion of the fluorescent labelling was performed (i.e. 4 hybridisations per comparison) in order to eliminate labelling biases (Martin-Magniette et al., 2005). To prepare the samples for hybridisation, a first reverse transcription step was performed, followed by in vitro transcription (to produce sufficient cRNA for all comparisons), and then a second reverse transcription with incorporation of the fluorochromes dCTP-Cy3 or dCTP-Cy5. Hybridisation on the slide was performed after purification and quantification of the samples.

The raw data provided by the Transcriptome platform was first transformed into Log 2 (ratio) before being normalised using the Loess method (Yang et al., 2002) to correct for labelling bias. Differential gene expression analysis was performed using the Limma test and the Benjamin-Hochberg correction was applied to correct the p-values for multiple tests.

We considered that the genes were differentially expressed on the basis of 2 criteria: a p-value (with FDR, False Discovery Rate)<0.05 and a logRatio of at least 1.25 (whether positive or negative). Venn diagrams were made to represent the number of shared or private genes between the 3 modalities (JA1, C1 and SI1) using the VennDiagram library of R software (Chen and Boutros, 2011). GO term annotations for each of the gene lists of the 3 modalities were obtained by agriGO (Du et al., 2010) and using the Solanum lycopersicum iTAG2.3 database. Functional classifications of GO terms were performed using Blast2GO software (Conesa et al., 2005).

Applying the retained filters (p-value <0.05 and LogRatio=1.25) on the 33913 Agilent microarray starting genes, a total of 958 and 188 genes were identified as differentially expressed (DE) for the 2 h and 48 h kinetic times respectively, regardless of the treatment modality. For the 2 h post-treatment analysis, only 13 DE genes were observed for the JA1 modality, compared to 340 for C1 and 942 for SI1. Similarly, for the 48 h post-treatment analysis, only 12 DE genes were observed for JA1, compared to 163 and 86 for C1 and SI1 respectively. The majority of DE genes for JA1 at 2 h are common to C1 and SI1. Similarly, the majority of DE genes for modality C1 at 2 h are common to modality SI1. The latter has the highest number of DE genes and the highest number of private genes, which we only find in this modality.

At 2 h, composition C1 impacts a greater number of genes than the equivalent contributions of green algal juice JA1 or the silica and trace element solution SI1.

The UP and DOWN genes expressed significantly only on the C1 composition highlight the synergy between algae and silica. These genes correspond to numerous metabolisms of defence to abiotic stresses and defence against biotic stresses. Thus we find genes relating to WRKY transcription factors, membrane receptor genes (LRR-like, Cystein rich receptor, receptor-like kinase RLK), defence genes (Pathogenesis-related PR-1, harpin-like induced protein, chitinase, endochitinase, Blight associated protein, phytosulfokine, beta glucanase), secondary metabolism genes, genes for the synthesis of the wall (xyloglucan endotransglucosidase, pectin esterase,) abiotic defence genes (Osmotin, K chanel, Cytochrome P450, HSP proteins, peroxidase, glutaredoxin, glutathione S-transferase like, thioredoxin), genes related to hormone signalling (Ethylene transcription factor, auxin response, AIA synthetase), genes for central metabolism and transport of ions or amino acids, in particular glutamate and histidine, and genes for DNA methylation for possible epigenetic effects (DNA methyltransferase).

Overall the C1 and SI1 modalities show the same effects on gene expression, but they are much more pronounced for the SI1 modality. This highlights a synergistic effect of the algae with the silica within the SI1 modality.

| Significantly | | | |
|---|---|---|---|
| expressed | | | DOWN |
| genes at 2 h | Total genes | UP genes | genes |
| Total | 958 | 834 | 124 |
| JA1 | 13 | 2 | 11 |
| C1 | 340 | 313 | 27 |
| SI1 | 942 | 826 | 116 |

At 48 h the trends change and it is the C1 composition that influences the transcriptome the most. We note that the genes impacted by JA1 are unchanged while SI1 has less influence.

| Significantly | | | |
|---|---|---|---|
| expressed | | | DOWN |
| genes at 48 h | Total genes | UP genes | genes |
| Total | 188 | 136 | 52 |
| JA1 | 12 | 2 | 10 |
| C1 | 163 | 117 | 46 |
| SI1 | 86 | 51 | 35 |

### Example 2: Biotic Stress Tests of Powdery Mildew on Tomato Conducted Under GHP Controlled Conditions Followed by Transcriptomic Analysis

The trial was conducted on young tomato plants of the powdery mildew-susceptible Plaisance variety grown in a greenhouse.

Oidium neolycopersici inoculum, the causal agent of powdery mildew, was obtained by multiplication on other healthy tomato plants. Inoculated leaflets showing symptoms were harvested and shaken in water to recover fresh spores. These spores were used as inoculum after calibration of the suspension.

At the fourth leaf stage of development, this inoculum was then sprayed up to the runoff limit on young cultivated plants, previously treated with one of the following solutions:
water only (NT);
a mixture of a commercial silica, trace elements and mineral salts composed of 9.7% expressed as SiO₂ in dry matter of monomeric orthosilicic acid, 78.9% in dry matter of polyethylene glycol and a tertiary amine, organic acid, intended to stabilise the silica, 3% in dry matter of trace elements and 8.3% in dry matter of mineral salts (SI1);
silica formulated from acidified potassium silicate composed of 10.8% expressed as SiO₂ in dry matter of monomeric orthosilicic acid and 89.2% of a silica stabiliser based on a natural polyol and a tertiary amine (SI2);
a mixture of acidified sodium silicate and mineral salts, composed of 49% expressed as SiO₂ in dry matter of monomeric orthosilicic acid and 51% in dry matter of mineral salts (SI3);
silica stabiliser SI2 alone (EXSI);
juice of red algae of the same species (Solieria chordalis) as that incorporated in composition C2 at 20% dry matter (JA2);
juice of red algae of the species Euchema spinosum at 20% dry matter (JA3);
C2 composition.

The doses applied to plants are diluted in the spray mixture and adjusted to allow comparisons between sources at the same dose of silica or the same dose of algal juice according to the table below:

| Modality | applied dose |
|---|---|
| NT | H20 |
| SI1 | 20 mg Si/L |
| Si2 | 20 mg Si/L |
| EXSI | 0.2% slurry as SIOLM |
| SI3 | 20 mg Si/L |
| JA2 | 2500 mg DM/L |
| JA3 | 2500 mg DM/L |
| C2 | 2% slurry |

The plants were then placed under conditions favourable for symptom development in the greenhouse.

A second application was made at the appearance of the first powdery mildew symptoms, corresponding to about 5% of the powdery leaf area on the plant treated with the NT solution.

The level of powdery mildew infestation in tomatoes was estimated from the percentage of leaf area affected by powdery mildew. The protective efficacy of the different treatments was then assessed by comparison with the untreated NT control.

Samples for transcriptomic analysis were taken 24 hours after the second application of the solutions with 3 biological replicates for each fertilisation modality:
“Without stress”: 2 leaflets from the same plant were pooled;
“Biotic stress”: 2 leaflets from 2 different plants were pooled.

A total of 48 samples were collected. RNA from these samples was extracted using the Qiagen RNeasy® Mini Kit and DNase treatment during extraction. After RNA sequencing, a first bioinformatics analysis of the Significantly Expressed Genes was performed on the individually expressed genes and a second bioinformatics analysis was performed using MapMan software, with application of the Sum Rank test, Wilcocson test and Benjamin Yiekutieli correction, in order to detect the metabolisms that are significantly impacted.

SI2 has an intermediate powdery mildew efficacy of 55.1%, while SI1, SI3, EXSI and JA2 have low efficacy, with 29.6%, 22.1%, 17.9% and 23.5% efficacy respectively.

The JA3-treated plants had an equivalent level of infection to the untreated NT control plants.

Composition C2 has a suitable protective efficacy against powdery mildew (82.9%), which is higher than the sum of the individual efficiencies of SI2 and JA2.

In comparison, the conventional phytosanitary reference has a 98.4% protection efficiency against tomato powdery mildew compared to untreated NT plants.

At the transcriptomic level, a large number of genes were significantly impacted (pValue <0.05) at 24 hours after application with the C2 modality, with relative mean expression levels Log₂ (C2/NT) greater than for the same genes in the JA2 or SI1 modalities. Over-expression of the genes can be observed in the absence of biotic stress, which persists in the presence of biotic stress.

### Example 3: Water Stress Trials on Tomato Conducted Under GLP Conditions Followed by Transcriptomic Analysis

The trial was conducted on young tomato plants of the Plaisance variety grown in a greenhouse, potted in 3 L pots in a mixture of GOM8 potting soil and sand (80%/20% v/v).

The leaves of these seedlings were sprayed twice with one of the following liquid solutions up to the limit of runoff:
water only (NT);
a mixture of a commercial silica, trace elements and mineral salts consisting of 9.7% expressed as SiO₂ on a dry basis of monomeric orthosilicic acid, 78.9% on a dry basis of polyethylene glycol and a tertiary amine, an organic acid, intended to stabilise the silica SiO₂, 3% on a dry basis of trace elements and 8.7% on a dry basis of mineral salts, (SI1);
silica formulated from acidified potassium silicate composed of 10.8% expressed as SiO₂ on a dry matter basis of monomeric orthosilicic acid and 89.2% of a silica stabiliser based on a natural polyol and a tertiary amine (SI2);
a mixture of acidified sodium silicate and mineral salts, consisting of 49% expressed as SiO₂ on a dry matter basis of monomeric orthosilicic acid and 51% on a dry matter basis of mineral salts (SI3);
juice of red algae of the same species (Solieria chordalis) as that incorporated in composition C2, at 20% dry matter (JA2);
juice of red algae of the species Euchema spinosum at 20% dry matter (JA3);
C2 composition.
The doses applied to plants are diluted in the spray mixture and adjusted to allow comparisons between sources at the same dose of silica or the same dose of algal juice according to the table below:

| modality | applied dose |
|---|---|
| NT | H20 |
| SI1 | 20 mg Si/L |
| SI2 | 20 mg Si/L |
| EXSI | 0.2% slurry |
| SI3 | 20 mg Si/L |
| JA2 | 2500 mg DM/L |
| JA3 | 2500 mg DM/L |
| C2 | 2% slurry |

These liquid solutions were sprayed at the fourth leaf stage of development (first application) and at the onset of the first symptoms of water stress resulting from a 50% reduction in water inputs 48 hours after the first application compared to a water regime without stress.

It was first verified that the fresh and dry above-ground biomass of the tomato plants were indeed impacted by water stress. It was found that the two untreated controls, stressed and unstressed, showed significant differences in biomass.

An evaluation of the phenotypic effects of each of the liquid solutions was carried out after 14 weeks of post-sowing culture, through observations or measurements of the following parameters or traits:
Height of the plant;
Flowering and fruiting;
Leaf biomass;
Number of sheets;
Vigour of the plant;
SPAD chlorophyll index.

It was observed that in the absence of water stress, the addition of SI1 increased plant height and that there was no significant gain in fresh biomass for SI1 and JA3.

Under water stress conditions, the application of the different liquid solutions did not seem to reduce the effect of stress on plant height compared to the untreated control, although growth was initially improved. On the other hand, the number of inflorescences per tomato plant was not significantly impacted by water stress. However, a slightly higher number of inflorescences was observed for the silica-treated varieties.

The number of leaves of the tomato plants was not significantly affected by water stress. However, the SI2, JA3 and C2 modalities had more leaves.

Under water stress conditions, it was also observed that the vigour of the plants of the JA2 and JA3 modalities is higher than that of the plants of the other modalities.

Thus, in this experiment, moderate water stress and few phenotypic effects were observed within the different modalities.

In addition, a transcriptomic analysis was carried out in these trials. A sample was taken 24 hours after the second application of the liquid solutions with 3 biological replicates per modality (2 leaflets from 2 different plants were pooled).

A total of 48 samples were collected. RNA from these samples was extracted using the Qiagen RNeasy® Mini Kit and DNase treatment during extraction. After RNA sequencing, a first bioinformatics analysis of the Significantly Expressed genes was performed and a second bioinformatics analysis was performed using MapMan software, with the application of Wilcoson's Sum Rank test and Benjamin Yiekutieli correction, in order to detect the metabolisms that are significantly impacted.

Differential gene expression was compared one by one between 2 modalities considering pValue <0.05 of the differences in expression means for the 3 biological replicates of each modality.

The Differentially Expressed (DE) genes for the JA2 object compared to the NT control (pValue <0.05) are mostly also Differentially Expressed for C2 and to a lesser extent for SI2. However, the differential expression levels in modality C2 are higher than those in JA2 and SI2, highlighting the synergy of algal extracts and silica in C2, which contains as much algal dry matter and silica as JA2 and SI2 respectively.

A large number of DE genes for C2 are not for JA2 or SI2, which is confirmed by the synergy of the algae extract, silica and trace elements in the C2 formulation.

It is interesting to note that the differentially expressed genes for modality C2 correspond to typical responses during abiotic stresses, whereas the trials were carried out in the absence of abiotic stress. We also note a gene (Solyc12g100330.1.ITAG2.4) linked to RNA/DNA methylation that reflects a possible epigenetic adaptation action.

Comparing the JA2 modality under water stress and no water stress conditions, it was also found that JA2 promotes the biosynthesis of many genes related to the two photosystems PSI and PSII and those for the conversion of light energy into chemical energy (ATP). Many membrane receptors and associated kinases for intracellular signalling are also significantly expressed. This indicates that JA2 contains ligands capable of being recognised by tomato cell receptors. Carrageenans, sulphated polysaccharides present in red algal juice and proteins, are suspected.

### Example 4: 2 Identical Efficacy and Selectivity Trials Against Downy Mildew on Grapevine Conducted Under GEP Conditions, in a Randomised Block Design with 8 Modalities and 4 Replications

Two identical trials were carried out in the field on vineyard microplots in Isle sur Tarn and Chancay, France.

In these trials, the leaves of the grapevines in the microplots were sprayed 10 times after flowering with one of the following solutions, each spray being spaced 8 days apart from the next:
water only (NT);
Champ Flo phytosanitary reference solution (registered trademark; AMM No. 9600097) based on copper sprayed at the approved dose for each application;
Romeo phytosanitary reference solution (registered trademark; AMM No. 2170654) at a registered dose of 0.235 L/ha at each application;
red algae juice of the same species (Solieria chordalis) as that incorporated in composition C2, at 20% dry matter, diluted (JA2) sprayed at a rate of 0.4 L/ha at each application;
silica formulated from acidified potassium silicate composed of 10.8% expressed as SiO₂ on a dry matter basis of monomeric orthosilicic acid and 89.2% of a silica stabiliser based on a natural polyol and a tertiary amine (SI2), sprayed at a rate of 0.4 L/ha at each application;
composition C2 diluted sprayed at a rate of 2 L/ha at each application.

Each modality was applied diluted in the spray mixture to provide the same dose of seaweed extract between modalities JA2 and C2 and the same dose of silica between modalities SI2 and

C2.

The repeatability of the trials was checked on two GEP trials with 6 replicates per modality on which the same treatment was applied, using a pooled analysis by ARM-ST.

The phytotoxicity of each of the solutions was evaluated, as well as the incidence and severity of downy mildew attacks on leaves and clusters.

The results obtained show that the solutions JA2, SI2 and C2, respectively, present an efficiency of 23%, 18% and 33% against mildew on the clusters.

A synergy between the algae and silica within C2 can be observed, which increases the effectiveness of protection, resulting in a reduction in the intensity of mildew symptoms on the grapes.

The efficacy against downy mildew of JA2 and C2 is even higher than that of ROMEO solution but still lower than Champ fib solution on both bunches and leaves.

It can therefore be envisaged to use the C2 composition with copper-based plant protection products in order to reduce the dose of copper sprayed on the vines.

### Example 5: Photosynthesis and Growth Trials on Wheat Conducted Under GEP Conditions, in a Randomised Block of Microplots with 6 Modalities and 6 Replications

The trials were carried out in the field on wheat microplots in Sainte Livrade, France.

In these trials, wheat microplots were sprayed with one of the following solutions at 2 L/ha:
water only (NT);
a mixture of a commercial silica, trace elements and mineral salts consisting of 9.7% expressed as SiO₂ on a dry matter basis of monomeric orthosilicic acid, 78.9% on a dry matter basis of polyethylene glycol and a tertiary amine, an organic acid, intended to stabilise the silica SiO₂, 3% on a dry matter basis of trace elements and 8.7% on a dry matter basis of mineral salts (SI1);
silica formulated from acidified potassium silicate composed of 10.8% expressed as SiO₂ on a dry matter basis of monomeric orthosilicic acid and 89.2% of an SiO₂ stabiliser based on a natural polyol and a tertiary amine (SI2);
juice of red algae of the same species (Solieria chordalis) as that incorporated in composition C2, at 20% dry matter, (JA2);
a mixture of 26.7% dry matter of a trace element mix containing copper, zinc, manganese and boron and 73.3% dry matter of mineral salts, (OLIGO);
composition C3.

Each modality was applied diluted in the spray mixture to provide the same dose of algae extract between modalities JA2 and C3 and the same dose of silica between modalities SI1, SI2 and C3. Moreover, the OLIGO modality was applied at the same dose of trace elements as the C3 modalities.

Yield and chlorophyll index were evaluated for each of the microplots. The results obtained are presented in the following table:

| | | Chlorophyll | | yield (% |
|---|---|---|---|---|
| | Chlorophyll | index (% | yield | compared |
| | index at | compared | (quintals | to |
| | D + 3 of | to untreated | per | untreated |
| Modality | application | control) | hectare) | control) |
| NT | 35.5 | 100% | 73.4 | 100% |
| SI1 | 37.5 | 106% | 74.5 | 101% |
| C3 | 38.6 | 109% | 75.8 | 103% |
| OLIGO | 37.7 | 106% | 72.5 | 99% |
| JA2 | 38.4 | 108% | 74.7 | 102% |
| SI2 | 38 | 107% | 75.8 | 103% |

The gain in chlorophyll index 3 days after application was found to be greatest with composition C3, where it is 9%.

It was also observed that the gain in yield was greatest after application of the C3 composition (+3%).

### Example 6: Blackrot (Phyllosticta ampelicida) Efficacy Trial on Grapevine, Conducted Under GEP Controlled Conditions, Randomised Block of 4 Objects and 4 Replicates

The trials were carried out on pot-grown vines.

In these trials, the leaves of the grapevines were sprayed 3 times with one of the following solutions, the first time at BBCH 14, the second time 7-10 days after the first application and the third time 7-10 days after the second application:
water only (NT);
C4 composition, at a rate equivalent to 5 L/ha;
reference plant protection product Metiram (registered trademark), dosed at 0.5 L/ha registered rate;
a mixture of Metiram at 0.5 L/ha with C4 at 5 L/ha.

Each modality is diluted in 200 L/ha of the spray mixture.

| | | | | relative |
|---|---|---|---|---|
| | | impact | severity | efficiency |
| Modality | dose | %. | %. | %. |
| NT | water only | 100.0% | 68.4% | 0% |
| C4 | 5 L/ha | 100.0% | 47.6% | 27.60% |
| Plant protection | 0.5 L/ha | 11.7% | 0.7% | 98.10% |
| reference | | | | |
| METIRAME | | | | |
| C4 + METIRAME | 5 + 0.5 | 85.0% | 20.9% | 68.70% |
| | L/ha | | | |

As can be seen in the summary table above, these trials have shown that C4 alone does not prevent the occurrence of Blackrot symptoms as well as when combined with Metiram.

In contrast, modality C4 had a significant effect in terms of reduced severity and efficacy against blackrot, although less than Metiram.

C4 therefore appears to be a valid candidate to provide partial protection against blackrot in combination with a plant protection product.

### Example 7: Maize Yield and Uptake Trials Conducted Under GEP Conditions, Randomised Block Design with 6 Replicates

The trials were carried out in the field on maize microplots in Alcala del Rio in Spain and in Saint Simon de Bressieu, France.

In these trials, maize microplots were sprayed with one of the following solutions at a rate of 2 l/ha at the 6-leaf stage (Alcala del rio) or 7-leaf stage (Saint Simon de Bressieu):
water only (NT);
only for the Alcala del rio site: a mixture of a commercial silica, trace elements and mineral salts consisting of 9.7% expressed as SiO₂ in dry matter of monomeric orthosilicic acid, 78.9% in dry matter of polyethylene glycol and a tertiary amine, an organic acid, intended to stabilise the silica SiO₂, 3% in dry matter of trace elements and 8.7% in dry matter of mineral salts (SI1);
silica formulated from acidified potassium silicate composed of 10.8% expressed as SiO₂ on a dry matter basis of monomeric orthosilicic acid and 89.2% of an SiO₂ stabiliser based on a natural polyol and a tertiary amine (SI2);
juice of red algae of the same species as that incorporated in composition C3 or C5, at 20% dry matter (JA2);
a mixture of 26.7% dry matter of a trace element mix containing copper, zinc, manganese and boron and 73.3% dry matter of mineral salts, (OLIGO);
only for the site of Alcala del rio: composition C3;
only for the Saint simon de Bressieu site: composition C5;
only at the Saint Simon de Bressieu site: a mixture of a red algae juice of the same species as that incorporated in composition C3 or C5, with 20% dry matter with trace elements and mineral salts, composed of 57.1% dry matter of red algae extract, 11.4% dry matter of trace elements and 31.4% dry matter of mineral salts (JA4);
only at the Saint Simon de Bressieu site: a mixture of a red seaweed juice of the same species as that incorporated in composition C3 or C5, with 20% dry matter, with trace elements and mineral salts, composed of 34.8% dry matter of red seaweed extract, 17.4% dry matter of trace elements and 47.8% dry matter of mineral salts (JA5)

Each modality was applied diluted in the spray mixture to provide the same dose of seaweed extract between modalities JA1, JA2, JA3 and C3 or C5 and the same dose of silica between modalities SI1, SI2 and C3 or C5.

Moreover, the OLIGO modality is applied at the same dose of trace elements as the C3 modalities.

An increase in yield of 7.5%, or 1t/ha, was observed at the Alcala del rio site compared to the untreated control after the addition of C3 and 12.7% at the Saint simon de Bressieu site after the addition of C5.

A synergy between seaweed extract, silica and trace elements in C3 and C5 was found to influence yield and mineral export in the plant. In comparison, SI2 and JA2 were found to have no effect on yield and OLIGO only improved yield by 1.9%. Furthermore, the yield gain with JA4 and JA5 was only 8% (p=0.03) and 2% (p=0.02) respectively.

An analysis of the plants at the Alcala del Rio site also showed that C3 improved mineral uptake by 5%, 3.8%, 8.7% and 12.2% respectively, in nitrogen, phosphorus, potassium and sulphur.

### Example 8: Powdery Mildew Efficacy Trial on Winter Wheat, Conducted Under GEP Conditions in a Randomised Block Design with 9 Modalities and 4 Replicates on 3 Sites

Identical trials were carried out in the field on microplots of winter wheat on 3 sites: Plélan le grand, Mauron and Haucourt en Cambrésie.

In these trials, one of the following solutions was sprayed on each of the microplots twice, at the BBCH37 and BBCH60 development stages:
water only (NT);
a Heliosulfur phytosanitary reference solution (registered trademark; AMM No. 9000222) based on sulphur sprayed at the approved dose for each application;
red algae juice of the same species as that incorporated in composition C4, at 20% dry matter (JA2), sprayed at a rate of 0.4 l/ha at each application;
a mixture of ⅙ JA1 and ⅚ JA2, sprayed at a rate of 0.4 l/ha at each application (JA6);
silica formulated from acidified potassium silicate composed of 10.8% expressed as SiO₂ in dry matter of monomeric orthosilicic acid and 89.2% of a SiO₂ stabiliser based on a natural polyol and a tertiary amine (SI2) sprayed at a rate of 0.2 L/ha at each application;
a mixture of ⅔ of a red algae juice of the same species as that incorporated in the C4 composition, at 20% dry matter with ⅓ of silica formulated from acidified potassium silicate composed of 10.8% expressed as SiO₂ in dry matter of monomeric orthosilicic acid and 89.2% of a silica stabiliser based on a natural polyol and a tertiary amine (JASI1) sprayed at a rate of 0.6 l/ha at each application;
C4 composition sprayed at a rate of 2 l/ha at each application.

Each modality was applied diluted in the spray mixture to provide the same dose of algae extract between modalities JA2, JA6 and C4 and the same dose of silica between modalities SI1, SI2 and C4. Furthermore, the OLIGO modality was applied at the same dose of trace elements as the C4 modality.

Based on the results of these three trials, a pooled analysis of yields and powdery mildew protection efficacy was performed.

This analysis reveals a systematic improvement in yield for the C4 cultivation modality, while no improvement is observed for JA2 and SI2, indicating that a synergistic effect between algal extract and silica takes place within C4.

The results obtained regarding the effectiveness of protection against powdery mildew are summarised in the following table:

| | | | | average |
|---|---|---|---|---|
| | | | | powdery |
| | | | | mildew |
| | | | Yield | protection |
| | | Yield | Hautcourt | efficiency vs. |
| | yield | Plelan le | en | TNT (zero) |
| Modality | Mauron | Grand | Cambresis | at 17 June |
| Untreated control | 100.00% | 100.00% | 100.00% | 0% |
| (NT) | | | | |
| JA2 | 102.00% | 99.80% | 98.90% | 0% |
| SI2 | 98.00% | 100.40% | 96.80% | 2.90% |
| JASI1 | 98.00% | 100.20% | 99.00% | 12.70% |
| C4 | 105.70% | 102.90% | 107.20% | 22.90% |
| Plant protection | | | | 44.40% |
| reference | | | | |
| Heliosulfur | | | | |

These results show that the efficacy of protection against powdery mildew is improved by 12.7% in JASI1, the synergy between seaweed extract and silica and that an even more effective synergy occurs between seaweed extract, silica and trace elements in C4, bringing the gain in efficacy to 22.9%. However, the efficacy of the algae extract and silica-based compositions remains lower than that of the phytosanitary reference Heliosulfur (registered trademark).

### Example 9: Effect Trials on Biomass and Mineral Export of Above-Ground Parts on Spring Barley, Under GEP Conditions, Microplots in Randomised Block Design with 6 Modalities and 6 Replications

Identical trials were carried out in the field on microplots of spring barley on 3 sites: Saint-georges du bois, Fontenay (36), and Bailleau l′évêque, all in France

In these trials, one of the following solutions was sprayed on each of the microplots on four occasions, at the developmental stages BBCH29, BBCH30, BBCH39 and BBCH51:
water only (NT);
red algae juice of the same species as that incorporated in composition C4, at 20% dry matter (JA2), sprayed at a rate of 0.4 L/ha at each application;
silica formulated from acidified potassium silicate composed of 10.8% expressed as SiO2 in dry matter of monomeric orthosilicic acid and 89.2% of a silica stabiliser based on a natural polyol and a tertiary amine (SI2), sprayed at a rate of 0.2 l/ha at each application;
C4 composition sprayed at 2 l/ha each application;
C4 composition sprayed at a rate of 1 l/ha at each application.

Each modality was applied diluted in the spray mixture to provide the same dose of seaweed extract between modalities JA2 and C4 and the same dose of silica between modalities SI2 and C4.

Based on the results of these three trials, a pooled analysis of the export of mineral elements in the aerial parts of the plants and on the yield was performed.

The export rate of calcium, magnesium, phosphorus and sulphur and the biomass found in the aerial parts for each of the cultivation methods are reported in the following table:

| | | | | | above- |
|---|---|---|---|---|---|
| | | | | | ground |
| | Ca | Mg | P | S | biomass- |
| | exported | exported | exported | exported | (g/60 |
| modality | %. | %. | %. | %. | plants) |
| Not | 100 | 100 | 100 | 100 | 107.8 |
| processed | | | | | |
| (NT) | | | | | |
| JA2 | 123.85 | 104.88 | 93.66 | 97.53 | 107.7 |
| SI2 | 95.91 | 95.95 | 92.87 | 94.02 | 105 |
| C4 at | 109.38 | 112.41 | 106.68 | 110.98 | 119.8 |
| 2l/ha | | | | | |
| C4 at | 100.02 | 104.66 | 99.23 | 96.01 | 117.5 |
| 1l/ha | | | | | |

It can be seen that only modality C4 induces a gain in export rate for both calcium, magnesium, phosphorus and sulphur, which confirms the synergistic effect of algae extract and silica on the export of mineral elements in the aerial parts of spring barley.

It was also observed that after only two applications of the C4 solution, the treated plants are ahead of schedule and are richer in mineral elements in the aerial parts, especially for the highest dose of C4 sprayed.

Regarding yield, there is a significant improvement in yield for the highest dose of C4, as can be seen in the summary table below:

| Modality | Performance |
|---|---|
| Untreated control NT | 100.00% |
| JA2 | 101.70% |
| SI2 | 97.50% |
| C4 at 1l/ha | 100.90% |
| C4 at 2l/ha | 102.20% |

1. Use of an organo-mineral composition by foliar application to stimulate plant development in the presence of at least one abiotic stress, said composition comprising algae extract and soluble silica in aqueous solution.

2. The use of an organo-mineral composition according to claim 1, characterised in that said composition comprises the following compounds

| | |
|---|---|
| algae extract | 5 to 50% |
| soluble silica expressed as SiO₂ | 0.5 to 2.5% |
| nutritive mineral salts | 0 to 30% |
| trace elements | 0 to 12% |
| organic acids | 0 to 30% |

the percentages being expressed by weight of dry matter of each of said compounds with respect to the total weight of dry matter of said organo-mineral composition.

3. The use of an organo-mineral composition according to claim 1, characterised in that the percentage of algae extract is between 5 and 30% of dry matter with respect to the total dry matter of the composition.

4. The use of an organo-mineral composition according to claim 1, characterised in that the percentage of soluble silica is between 1.2 and 2.4% of dry matter with respect to the total dry matter of the composition.

5. The use of an organo-mineral composition according to claim 1, characterised in that said soluble silica comprises stabilized monomeric orthosilicic acid.

6. The use of an organo-mineral composition according to claim 1, characterised in that said use further improves the resistance of plants to phytopathogenic fungi.

7. The use of an organo-mineral composition according to claim 6, characterised in that said phytopathogenic fungus belongs to the group comprising at least:
botrytis;
microorganism causing downy mildew;
fungus causing oidium;
fungus causing septoria;
fungus causing rust.

8. The use of an organo-mineral composition according to claim 1, characterised in that said algae extract of said composition is an extract of red algae and/or green algae.

9. The use of an organo-mineral composition according to claim 8, characterised in that said algae extract is an extract of algae of the Solieriaceae and/or Ulvaceae family.

10. The use of an organo-mineral composition according to claim 1, characterised in that said composition is in liquid form.

11. The use of an organo-mineral composition according to claim 1, characterised in that said use is carried out in 1 to 10 applications per crop cycle at a dose of between 0.5 and 5 L/ha/application diluted in a spray mixture intended to be applied at a dose of between 50 and 1000 L/ha.

12. The use of an organo-mineral composition according to claim 1, characterised in that said development of said plant results in the improvement of at least one of the following parameters under normal conditions or under biotic and abiotic stress
plant height;
stem diameter;
photosynthetic activity;
vegetative development index NDVI;
gross or dry above-ground biomass;
fresh or dry root biomass;
mineral content of above-ground biomass;
number of leaves;
number of flowers;
number of fruits;
yield;
quality parameter of the crop, such as the quality of the grape must, the protein content or the baking quality of a grain;
genomic and/or transcriptomic and/or metabolomic changes in the plant in the absence of stress, under biotic stress and/or under abiotic stress.

13. The use of an organo-mineral composition according to claim 1, characterised in that said plant is an annual or biennial field crop or a perennial plant.

14. The use of an organo-mineral composition according to claim 1, characterised in that said mineral nutrient salts are a source of nitrogen, potassium, phosphorus and/or sulphur.

15. An aqueous composition comprising the following compounds:

| | |
|---|---|
| algae extract | 5 to 50% |
| soluble silica expressed as SiO₂ | 0.5 to 2.5% |
| mineral nutrient salts | 0 to 30% |
| trace elements | 0 to 12% |
| organic acids | 0 to 30%. |

the percentages being expressed as weight of dry matter of each of said compounds with respect to the total weight of dry matter of said organo-mineral composition, the total being adjusted to 100%.
